(19) United States
(12) Patent Application Publication
(10) Pub. No.: US 2019/0205815 A1
(43) Pub. Date: Jul. 4, 2019

(54) SMART EMPTY CONTAINER REPOSITIONING RE-PLANNING SYSTEM UNDER INACCURATE DEMAND FORECAST

(71) Applicant: SAP SE, Walldorf (DE)

(72) Inventors: Leiyi Yao, Shanghai (CN); Xin Chen, Nanning (CN); Likun Hou, Shanghai (CN)

(21) Appl. No.: 15/857,890

(22) Filed: Dec. 29, 2017

(51) Int. Cl. G06Q 10/08; G06Q 10/06

(52) U.S. Cl. CPC G06Q 10/083; G06Q 10/06316

(57) ABSTRACT

Implementations of the present disclosure include methods, systems, and computer-readable storage mediums for receiving input data including one or more original instructions for empty container movement within a network, network configuration data, and a delta supply/demand (S/D) plan, the delta S/D plan defining changes to supply and demand for empty containers at respective locations with respect to a previous S/D plan, processing, by a preprocessor and constraint generator, at least a portion of the input to provide one or more constraints, determining, by a delta balancing optimizer, at least one delta instruction based on the one or more constraints, the network configuration data, and the one or more original instructions, determining whether the at least one delta instruction is of an unacceptable type, and providing one or more refined delta instructions in response to determining that the at least one delta instruction is of an unacceptable type.

### BACKGROUND

Commercial goods can be packed into shipping containers for transportation between destinations by trucks, trains, and/or shipping vessels. Transporting the goods using shipping containers enables efficient loading and unloading of the shipping containers, as well as standardization of shipments and handling equipment. The shipping containers can be moved from source container depots to destination container depots by a first shipping channel (e.g., train), and can be moved from customer locations to container depots, and from container depots to other customer locations by a second shipping channel (e.g., truck). The transportation network may be complex, requiring advance planning taking into account schedules, capacities, speed, and cost.

Empty container repositioning (ECR) (also referred to as empty container balancing (ECB)) is a process for repositioning empty shipping containers to fulfill current and future demand. In some examples, demand can fluctuate due to the global trade imbalance, which can result in export-dominant ports having container shortages, while import-dominant ports accumulate empty containers. Typically, the main concern is the transportation of loaded containers, because movement of loaded containers is the source of profit.

However, because of trade imbalance, if the empty container flows are not managed carefully, the loaded flows and the entire shipping network will not operate efficiently. If empty containers cannot be located in the demand points at the requested time, the shipping companies have to make decisions (e.g., either load rejection or container leasing), which may reduce customer satisfaction, and/or increase operational costs. In addition, ECR is a major cost driver as it does not bring any direct profit. Consequently, ECR is a significant consideration in container management, and needs careful planning to ensure empty containers are transferred in a timely and efficient manner.

### SUMMARY

Implementations of the present disclosure include computer-implemented methods for empty container repositioning (ECR). More particularly, implementations of the present disclosure are directed to an ECR re-planning platform to mitigate inaccurate demand forecasts.

In some implementations, actions include receiving input data including one or more original instructions for empty container movement within a network, network configuration data, and a delta supply/demand (S/D) plan, the delta S/D plan defining changes to supply and demand for empty containers at respective locations with respect to a previous S/D plan, processing, by a preprocessor and constraint generator, at least a portion of the input to provide one or more constraints, determining, by a delta balancing optimizer, at least one delta instruction based on the one or more constraints, the network configuration data, and the one or more original instructions, determining whether the at least one delta instruction is of an unacceptable type, and providing one or more refined delta instructions in response to determining that the at least one delta instruction is of an unacceptable type. Other implementations include corresponding systems, apparatus, and computer programs, configured to perform the actions of the methods, encoded on computer storage devices.

These and other implementations may each optionally include one or more of the following features: at least one refined delta instruction includes one of a new delta instruction, and a modified delta instruction; the modified delta instructions includes a change in one or more of a route, a location, and a size of container; unacceptable types include unnecessary repositioning, use of a new route that is absent from one or more original instructions, and longer route; the constraints include one or more of a time constraint, and a container availability constraint; a refined delta instruction is provided based on merging of multiple original instructions; and a refined delta instruction is provided based on modifying an original instruction to include a shorter route than a longer route provided in the original instruction.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example conceptual architecture in accordance with implementations of the present disclosure.

FIG. 2A schematically depicts an example empty container repositioning (ECR) re-planning platform in accordance with implementations of the present disclosure.

FIG. 2B depicts example inputs in accordance with implementations of the present disclosure.

FIG. 2C depicts example outputs in accordance with implementations of the present disclosure.

FIGS. 3A-3C depicts example use cases in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for empty container repositioning (ECR). More particularly, implementations of the present disclosure are directed to an ECR re-planning platform to mitigate inaccurate demand forecasts. In some implementations, actions include receiving input data including one or more original instructions for empty container movement within a network, network configuration data, and a delta supply/demand (S/D) plan, the delta S/D plan defining changes to supply and demand for empty containers at respective locations with respect to a previous S/D plan, processing, by a preprocessor and constraint generator, at least a portion of the input to provide one or more constraints, determining, by a delta balancing optimizer, at least one delta instruction based on the one or more constraints, the network configuration data, and the one or more original instructions, determining whether the at least one delta instruction is of an unacceptable type, and providing one or more refined delta instructions in response to determining that the at least one delta instruction is of an unacceptable type.

To provide further context for implementations of the present disclosure, ECR planning can be divided into two phases: long-term planning/initial instructions, and short-term re-planning/delta instructions. In the long-term planning phase (e.g. one to several months), the ECR initial instructions (also referred to as original instructions) are generated based on a supply and demand forecast. In some examples, the initial instructions provide expected movements of empty containers. The long-term planning, however, can be inaccurate. Consequently, the short-term planning phase (e.g. weekly) provides more accurate, updated instructions, referred to as delta instructions, based on short-term demand.

In practice, ECR is globally planned by the headquarters of shipping companies. ECR, however, usually involves ports on different continents or areas and local offices are in charge of execution. When long-term planning is executed, the headquarters delivers the initial instructions to local offices to arrange future ECR operations. When delta instructions are provided based on short-term demand, shipping companies prefer more robust instructions instead of modifying most of the original instructions. This is because it takes time to digest the modified instructions during operation. If the initial instructions are modified in the headquarters' plan, but are not timely transferred and confirmed by local offices, there may be conflicts in which instructions are active. This can result in ECR failure, leading to losses. Accordingly, there is a need for smart creation of delta instructions addressing inaccurate forecast, such that the delta instructions minimize the impact on the original plan.

In view of the foregoing, implementations of the present disclosure provide an ECR platform that avoids unnecessary ECR, uses a new shipping line not in the original instructions, and detects undesired, longer routes. Further, and as described herein, the ECR platform of the present disclosure can optimize the delta instructions, and provide various re-planning options that can be used to consider tradeoffs between ECR cost reduction, and execution feasibility.

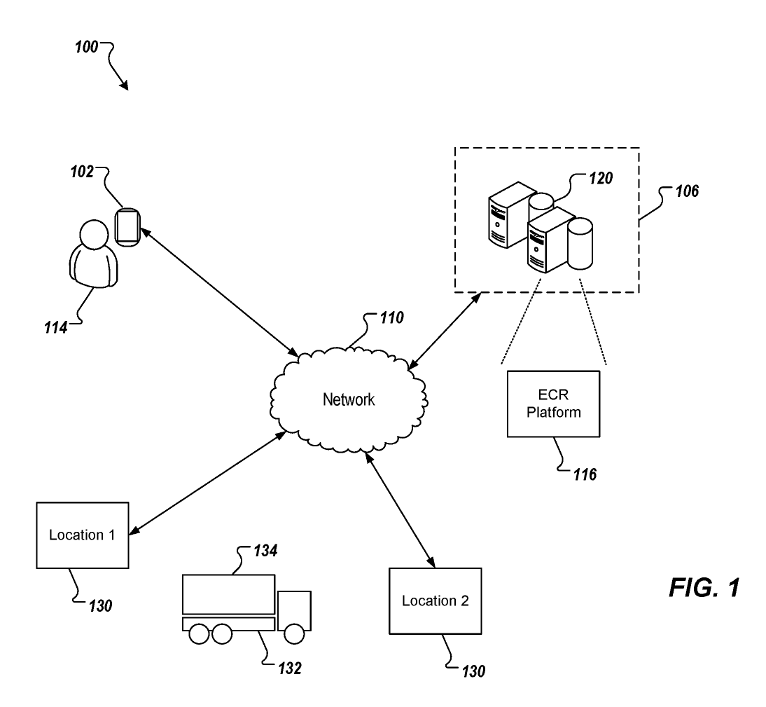

FIG. 1 depicts an example conceptual architecture 100 in accordance with implementations of the present disclosure. The example conceptual architecture 100 includes a computing device 102, a back-end system 106, and a network 110. In some examples, the computing device 102 is used by a user 114 to log into and interact with a ECR platform of the present disclosure, which is hosted on the back-end system 106.

In the depicted example, the computing device 102 is provided as a mobile computing device. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., the computing device 102), and back-end systems (e.g., the back-end system 106). In some examples, the network 110 can be accessed over a wired and/or a wireless communications link. For example, mobile computing devices, such as smartphones can utilize a cellular network to access the network 110.

In the depicted example, the back-end system 106 includes at least one server system 120. In some examples, the at least one server system 120 hosts one or more computer-implemented services that users can interact with using computing devices. For example, the back-end system 106 hosts the computer-implemented ECR platform 116 of the present disclosure. In some examples, the user 114 is an agent of an entity that executes ECR based on initial instructions, delta instructions, and added instructions, and/or modified instructions, as described herein, and interacts with the ECR platform 116 hosted on the back-end system 106 using the computing device 102. In some examples, the ECR platform 116 is at least partially hosted on SAP HANA, which can be described as an operational database system, and in-memory computing platform, which is provided by SAP SE of Walldorf, Germany.

In some examples, the computing device 102 includes a computer-executable application executed thereon, which can be used to log into the ECR platform 116 of the present disclosure. In some examples, the computing device 102 includes a web browser application executed thereon, which can be used to display one or more web pages of the ECR platform 116 of the present disclosure.

The example conceptual architecture 100 further includes multiple locations 130, and a transport vehicle 132 that transports a container 134 between the locations 130. Although the transport vehicle 132 is depicted as a truck, it is contemplated that implementations of the present disclosure can be realized with any appropriate transport vehicle (e.g., truck, train, ship). The multiple locations 130 represent a portion of a transportation network, within which containers, such as the container 134, are transported. Example locations include, without limitation, container depots, and customer locations, and shipping ports. Generally, the locations 130 represent locations, at which empty containers may be loaded with goods, the loaded or full shipping containers may be sent to other locations, loaded or full containers may be received, and goods may be unloaded or removed from loaded or full shipping containers. Containers, such as the container 134, may be transported between locations, such as the locations 130, by scheduled paths recorded in initial instructions.

In some examples, containers, such as the container 134, are sized in units of cargo capacity. An example unit of cargo capacity includes twenty-eight foot unit (TEU), which is based on the volume of a 20-foot-long (6.1 m) intermodal container, which can be described as a standard-sized metal container that can be transferred between different modes of transportation (e.g., ships, trains, trucks). Although TEU is used herein, it is contemplated that implementations of the present disclosure can be realized using any appropriate units of cargo capacity.

In some implementations, the initial instructions (also referred to as original instructions) are based on predicted supply and demand plans. An example system for providing initial instructions is provided in commonly assigned U.S. Pub. 2017/0178073, which is expressly incorporated herein by reference in the entirety for all purposes. In general, the system of U.S. Pub. 2017/0178073 determines optimal routes, and numbers and types of empty containers to be transported on the optimal routes. These optimized routes are recorded in the initial instructions. The optimized routes and numbers of empty containers may balance, to the extent possible, the empty containers between container depots by balancing supply and demand for empty containers at locations to reduce the demand or shortage of empty containers at export-dominant ports, and to reduce the supply or excess of unnecessary empty containers at import-dominant ports. The optimized routes and numbers of empty shipping containers transported on the optimized routes may, for example, minimize the number of empty containers at container depots that receive a high number of full containers, and maximize the number of empty containers at container depots that send a high number of full containers.

An issue arises in that the original supply/demand plan may be inaccurate. For example, the optimized routes described above can be determined based on a supply/demand forecast, which may change after the optimized routes are determined. Consequently, so called delta instructions are provided, which are intended to address inaccuracies in the predicted supply/demand plan. However, the delta instructions themselves may be non-optimal. Accordingly, the ECR platform of the present disclosure provides optimized delta instructions to address inaccuracies in original supply/demand plans, as described in further detail herein.

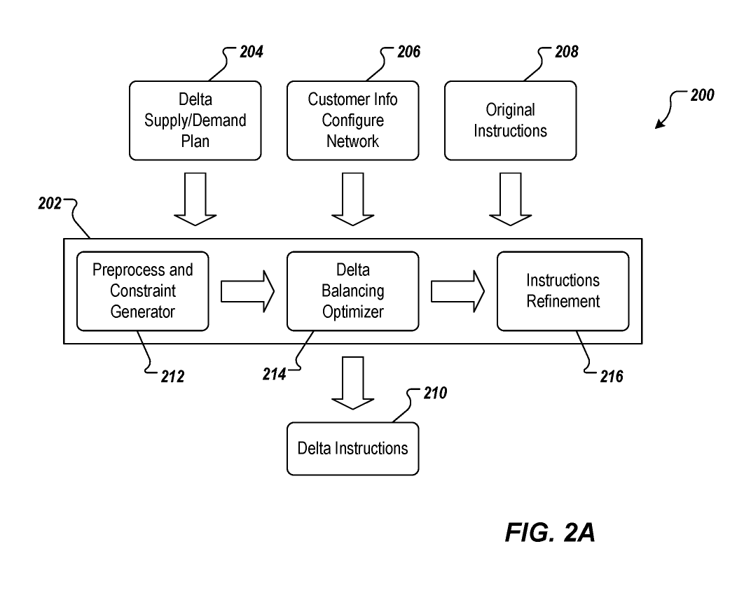

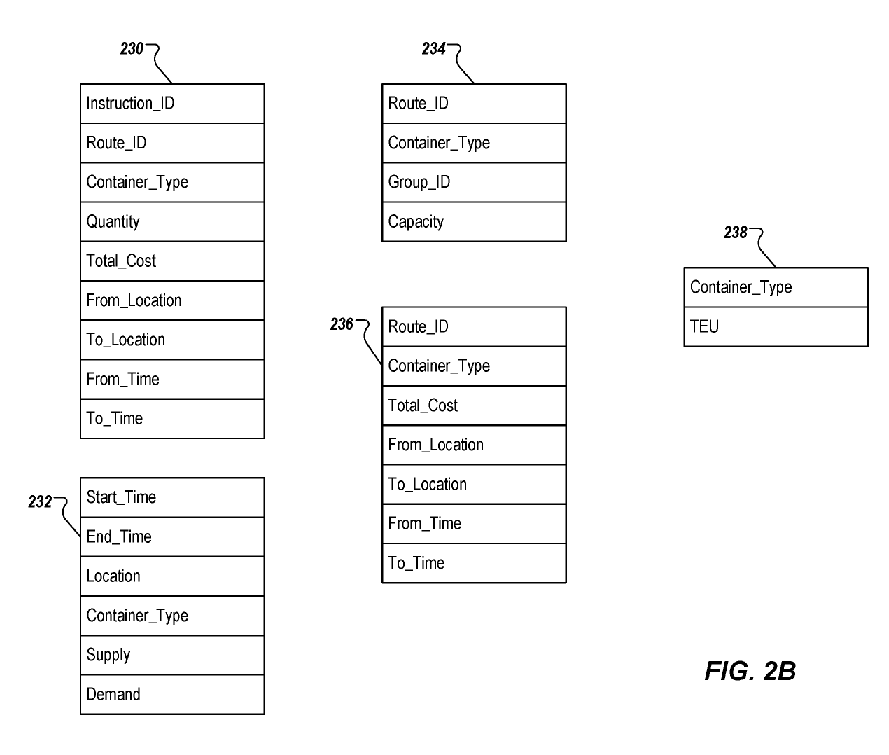

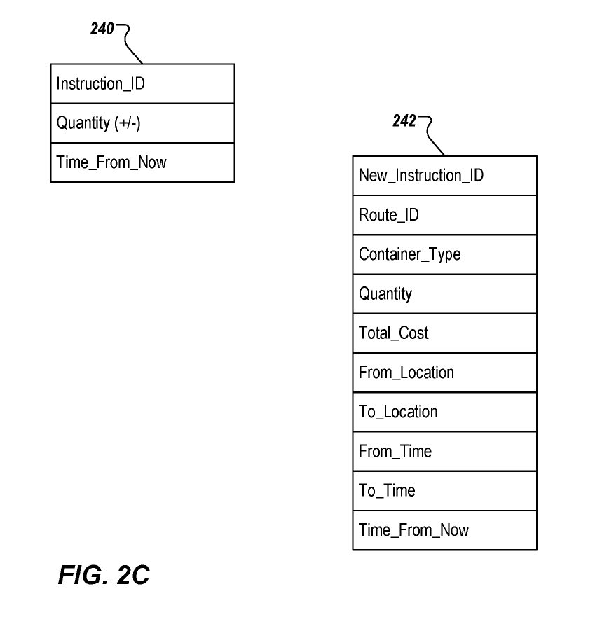

FIG. 2A schematically depicts an example ECR re-planning platform 200 in accordance with implementations of the present disclosure. The example platform 200 includes an optimization engine 202, which receives input, and provides output. In some examples, input includes a delta supply/demand (S/D) plan 204, customer information and network configuration 206, and original instructions 208. In some examples, the optimization engine 202 is executed within a database system, such as SAP HANA introduced above.

In some implementations, each of the inputs 204, 206, 208 is provided in computer-readable form (e.g., data tables). In some implementations, the optimization engine 202 processes the input 204, 206, 208 to provide delta instructions 210 as output (e.g., in a computer-readable form). In some examples, the original instructions 208 are provided from an optimized route determination platform, such as that disclosed in U.S. Pub. 2017/0178073. In some examples, the delta S/D plan 204 is provided from a S/D platform that determines predicted supply and demand, as well as current (actual) supply and demand for multiple locations in a network. In some examples, the delta S/D plan provides a difference (delta) between an original S/D plan, which was to be executed using the original instructions 208, and a current S/D forecast correction. In some examples, the delta S/D plan indicates modification of the original instructions 208.

In some implementations, the optimization engine 202 includes a preprocess and constraint generator 212, a delta balancing optimizer 214, and an instruction refinement module 216. As described in further detail herein, the optimization engine 202 bridges the planning level and operation level of ECR by combining long-term and short-term instructions. In some implementations, the optimization engine 202 processes the inputs 204, 206, 208 to optimize the short-term operational instructions based on long-term instructions. Further, multiple re-planning choices are provided to enable selective tradeoff between ECR cost reduction, and execution complexity.

FIG. 2B depicts example inputs in accordance with implementations of the present disclosure. The example inputs include an original instructions table 230, a delta S/D plan table 232, an updated capacity table 234, a network information table 236, and a TEU transform table 238. In the depicted example, the original instructions table 230 includes the following fields:

| Field | Description |
|---|---|
| INSTRUCTION_ID | Unique ID of an instruction |
| ROUTE_ID | Unique ID of a route |
| CONTAINER_TYPE | Type of container |
| QUANTITY | Amount of containers |
| TOTAL_COST | Total cost |
| FROM_LOCATION | Start location |
| TO_LOCATION | Destination location |
| FROM_TIME | Departure time |
| TO_TIME | Arrival time |

In the depicted example, the delta S/D plan table 232 includes the following fields:

| Field | Description |
|---|---|
| START_TIME | Departure time |
| END_TIME | Arrival time |
| LOCATION | Location |
| CONTAINER_TYPE | Type of container |
| SUPPLY | Amount of container available for use |
| DEMAND | Amount of container needed |

In the depicted example, the updated capacity table 234 includes the following fields:

| Field | Description |
|---|---|
| ROUTE_ID | Unique ID of a route |
| CONTAINER_TYPE | Type of container |
| GROUP_ID | Unique ID of a group |
| CAPACITY | Updated capacity |

In the depicted example, the network information table 236 includes the following fields:

| Field | Description |
|---|---|
| ROUTE_ID | Unique ID of a route |
| CONTAINER_TYPE | Type of container |
| TOTAL_COST | Total cost |
| FROM_LOCATION | Start location |
| TO_LOCATION | Destination location |
| FROM_TIME | Departure time |
| TO_TIME | Arrival time |

In the depicted example, the TEU transform table 238 includes the following fields:

| Field | Description |
|---|---|
| CONTAINER_TYPE | Type of container |
| TEU | Equivalent volume a different type of |
| | container transformed into TEU. |

FIG. 2C depicts example outputs in accordance with implementations of the present disclosure. The example outputs include a modified instruction table 240, and an add instruction table 242. In the depicted example, the modified instruction table 240, includes the following fields:

| Field | Description |
|---|---|
| INSTRUCTION_ID | ID of instruction being modified |
| QUANTITY | Amount of containers |
| TIME_FROM_NOW | Duration between CURRENT_TIME and |
| | FROM_TIME |

In the depicted example, the add instruction table 242 includes the following fields:

| Name | Description |
|---|---|
| NEW_INSTRUCTION_ID | ID of new instruction |
| ROUTE_ID | ID of route |
| CONTAINER_TYPE | Type of container |
| QUANTITY | Amount of containers |
| TOTAL_COST | Total cost of the instruction |
| FROM_LOCATION | Start location |
| TO_LOCATION | Destination |
| FROM_TIME | Departure time |
| TO_TIME | Arrival time |
| TIME_FROM_NOW | Duration between |
| | CURRENT_TIME and FROM_TIME |

In some examples, the shorter that the Time_From_Now value is, the more difficult the modified or added instruction is to execute.

In accordance with implementations of the present disclosure, the ECR platform provides a multi-phase approach to handle inaccurate demand forecasts. In some implementations, in a first phase, the delta balancing optimizer solves the unbalanced delta S/D plan 204 that results from the inaccurate demand estimation. However, the output of the delta balancing optimizer 214 may not be the best solution for rebalance. Consequently, the instructions refinement module 216 refines the instructions provided from the delta balancing optimizer 214 to provide the output 210.

In some implementations, the preprocess and constraint generator 212 executes a series of queries (e.g., SQL queries) over multiple tables to provide aggregate tables that are input to the delta balancing optimizer 214. In some examples, the multiple table include customer-provided tables (e.g., in CSV format), which are converted for query processing within the optimization engine 202. The aggregate tables include fields, and respective values that can be used as constraints for providing the delta instructions 210. Example constraints can include, without limitation, route distance, which can be a cost constraint, and time, which can be a feasibility constraint.

In some implementations, the delta balancing optimizer 214 provides initial delta instructions based on the delta S/D plan 204 (e.g., which indicates current S/D requirements at respective locations), constraints provided from the preprocess and constraint generator, as well as the customer information and network configuration 206. In some examples, the delta balancing optimizer selects routes and provides corresponding delta instructions as disclosed in U.S. Pub. 2017/0178073.

For example, delta instructions including routes for transporting containers, including repositioning empty containers, and/or numbers and types of empty containers to transport over the optimal routes. The routes and/or number of empty containers can be determined based on the delta S/D demand 204, and the customer information and network configuration data 206. In some examples, the routes are determined to balance a supply and demand of empty containers at the container depots in view of the delta S/D plan 204. In an example implementation, one or more container depots may have a delta S/D value, where a positive value denotes an excess or supply of empty containers, and a negative value denotes a shortage or demand of empty containers. The delta instructions can be provided to bring a sum of absolute values of the supply/demand values for the container depots as close to zero as possible.

In some implementations, the instructions refinement module 216 processes the initial delta instructions provided from the delta balancing optimizer 214 to provide modified delta instructions as the output 210. In some examples, the initial delta instructions are processed to determine whether any fall into one of a plurality of types (or categories) of unacceptable instructions. If an initial delta instruction is determined to be one of the types, a modified delta instruction, and/or an additional delta instruction are provided. Example types include, without limitation, unnecessary repositioning (e.g., the delta instruction would result in unnecessary movement of a container), use of a new route not in the original instructions (e.g., the delta instruction adds a route that was not part of the original instructions), and longer route (e.g., the delta instructions use a longer route when a shorter route is available).

In some implementations, the instructions refinement module 216 determines whether the delta instruction includes an unnecessary repositioning. In response to determining that the delta instructions are unnecessary repositioning, the original instructions are merged into one instruction by reducing the unnecessary repositioning. In some implementations, the instructions refinement module 216 determines whether the delta instructions include use of a new route not in the original instructions. In response to determining that the delta instructions includes use of a new route the original instructions are merged into one instruction, if the capacity is allowed (e.g., there is sufficient capacity in the containers). In some implementations, the instructions refinement module 216 determines whether the delta instructions include use of a longer route. In response to determining that the delta instructions include use of a longer route, the original, longer distance instruction is modified into a shorter distance instruction by reducing the longer distance repositioning.

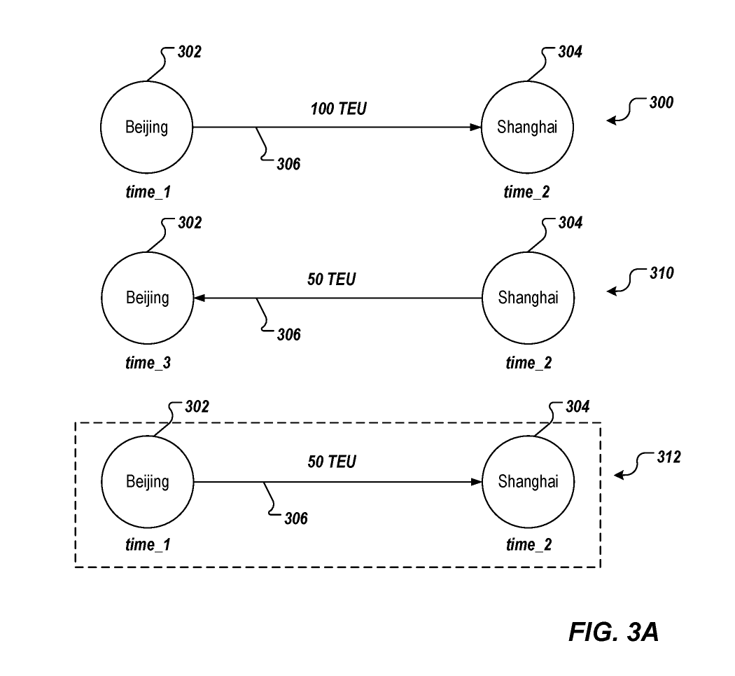

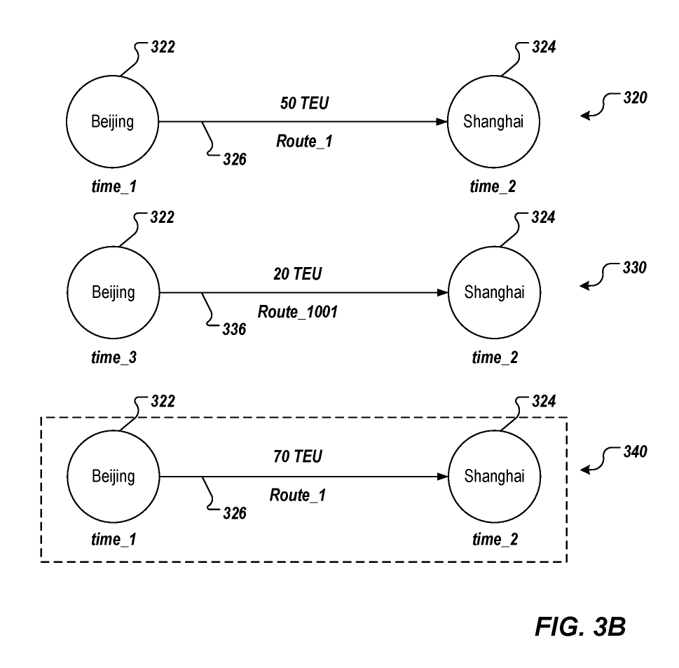

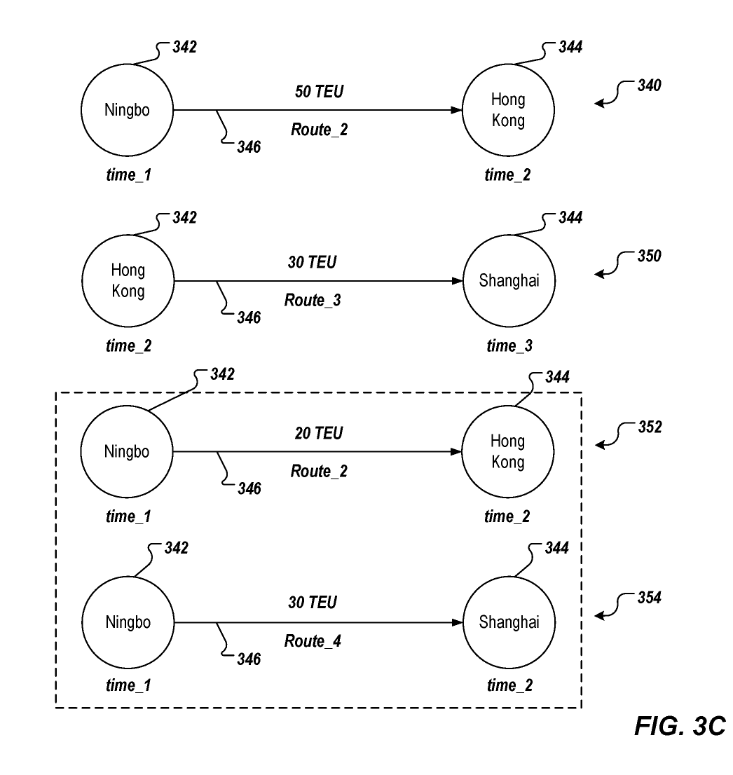

FIGS. 3A-3C depicts example use cases in accordance with implementations of the present disclosure. The example of FIG. 3A depicts an example delta suggestion that would result in an unnecessary repositioning. The example of FIG. 3B depicts an example delta suggestion that would result in unnecessary use of a shipping line along a new route. The example of FIG. 3C depicts an example delta suggestion that would result in an unnecessary, longer route.

With particular reference to FIG. 3A, a graph 300 includes nodes 302, 304, and an edge 306 between the nodes 302, 304. The nodes 302, 304 represent respective locations (e.g., Beijing, Shanghai, respectively), and the edge 306 represents a route between the locations. In the depicted example, an original instruction includes moving 100 TEU from Beijing at time interval 1 (time_1) to Shanghai at time interval 2 (time_2). In this example, due to an inaccurate demand estimate, a delta suggestion provides instructions to move 50 TEU from Shanghai at time_2 to Beijing at time interval 3 (time_3). This is depicted in a graph 310 of FIG. 3A. The delta suggestion, however, is non-optimal, and would result in inefficiencies. Accordingly, the ECR platform of the present disclosure provides a modified instruction (e.g., provided as output in a modified instruction table 240 of FIG. 2C), which reduces 50 TEU in the original instruction. Accordingly, the original instruction is modified to move 50 TEU from Beijing at time_1 to Shanghai at time_2 instead of the original 100 TEU. This is depicted in a graph 312 of FIG. 3A. This modification will release 50 TEU capacity for the shipping line from Beijing at time_1 to Shanghai at time_2, and 50 TEU capacity from Shanghai at time_2 to Beijing at time_3. The shipping capacity information is updated accordingly.

With particular reference to FIG. 3B, a graph 320 includes nodes 322, 324, and an edge 326 between the nodes 322, 324. The nodes 322, 324 represent respective locations (e.g., Beijing, Shanghai, respectively), and the edge 326 represents a route between the locations. In the depicted example, an original instruction includes moving 50 TEU from Beijing at time_1 to Shanghai at time_2 by route 1. Due to an inaccurate demand estimation, a delta suggestion provides instructions to move 20 TEU from Beijing at time_1 to Shanghai at time_2 by another route, route 1001. This is depicted in a graph 330 of FIG. 3B. The delta suggestion, however, is non-optimal, and would result in inefficiencies. Accordingly, the ECR platform of the present disclosure provides a modified instruction (e.g., provided as output in a modified instruction table 240 of FIG. 2C). In this example, the ECR platform checks the capacity to determine whether there is sufficient capacity for route 1 to carry more than 20 TEU. In response to determining that there is sufficient capacity for route 1 to carry more than 20 TEU, the delta suggestion is rejected, and a modified instruction is provided to add 20 TEU to the original instruction. This is depicted in a graph 332 of FIG. 3B.

With particular reference to FIG. 3C, a graph 340, which includes nodes 342, 344, and an edge 346 between the nodes 342, 344. The nodes 342, 344 represent respective locations (e.g., Ningbo, Hong Kong, respectively), and the edge 346 represents a route between the locations. In the depicted example, original instructions include moving 50 TEU from Ningbo at time_1 to Hong Kong at time_2 by route 2. Due to an inaccurate demand estimation, a delta suggestion is provided, which includes moving 30 TEU from Hong Kong at time_2 to Shanghai at time_3 by route 3. This is depicted in a graph 350 of FIG. 3C. The delta suggestion, however, is non-optimal, and would result in inefficiencies. For example, Hong Kong to Shanghai is a much longer route than Ningbo to Shanghai. Accordingly, the ECR platform of the present disclosure provides a modified instruction, which includes reducing 30 TEU in route 2 of the original instruction. This is depicted in a graph 352 of FIG. 3C. Further, the ECR platform provides a new instruction to move 30 TEU from Ningbo at time_1 to Shanghai at time_2 along route 4. This is depicted in a graph 354 of FIG. 3C. Accordingly, the modified instruction and new instruction provided by the ECR platform save transportation capacity, and shorten the transport duration by choosing a new, shorter route, route 4.

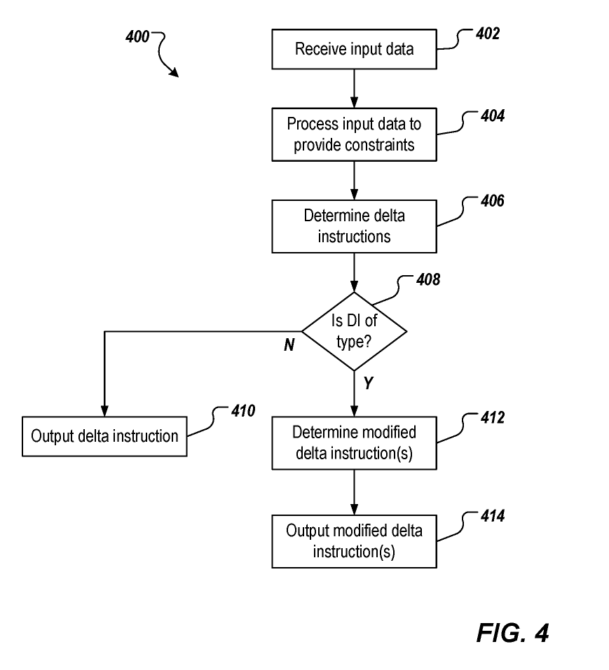

FIG. 4 depicts an example process 400 that can be executed in accordance with implementations of the present disclosure. In some implementations, the example process 400 may be performed using one or more computer-executable programs executed using one or more computing devices.

Input data is received (402). For example, and as described in detail herein, the input includes the delta S/D plan 204, the customer information and network configuration 206, and the original instructions 208. In some examples, the input is provided in respective tables received from a database. The input data is processed to provide one or more constraints (404). For example, and as described in detail herein, the preprocess and constraint generator 212 processes at least a portion of the input to provide one or more constraints.

One or more delta instructions are determined (406). For example, and as described in detail herein, the delta balancing optimizer processes at least a portion of the input in view of the constraints to provide the one or more delta instructions. For each delta instruction (DI) it is determined whether the delta instruction is of an unacceptable type (408). For example, and as described in detail herein, the instructions refinement module 216 determines whether a delta instruction is of an unacceptable type. Example unacceptable types include, without limitation, unnecessary repositioning (e.g., the delta instruction would result in unnecessary movement of a container), use of a new route not in the original instructions (e.g., the delta instruction adds a route that was not part of the original instructions), and longer route.

If the delta instruction is not of an unacceptable type, the delta instruction is provided as output (410). For example, the optimization engine 202 outputs the delta instruction as output 210. In some examples, the output delta instruction is provided to an ECR execution system, which provides instructions to one or more impacted locations (e.g., locations that are to act on the delta instruction) for repositioning of containers based on the delta instruction. If the delta instruction is of an unacceptable type, one or more modified delta instructions are determined (412). For example, and as described herein, the instruction refinement module 216 provides a modified instruction, an additional instruction, and/or removes a delta instruction (e.g., as depicted in the examples of FIGS. 3A-3C). The one or more modified delta instructions are provide as output (414). For example, the optimization engine 202 outputs the modified delta instruction(s) as output 210. In some examples, the output delta instruction(s) is/are provided to an ECR execution system, which provides instructions to one or more impacted locations for repositioning of containers based on the modified delta instruction(s).

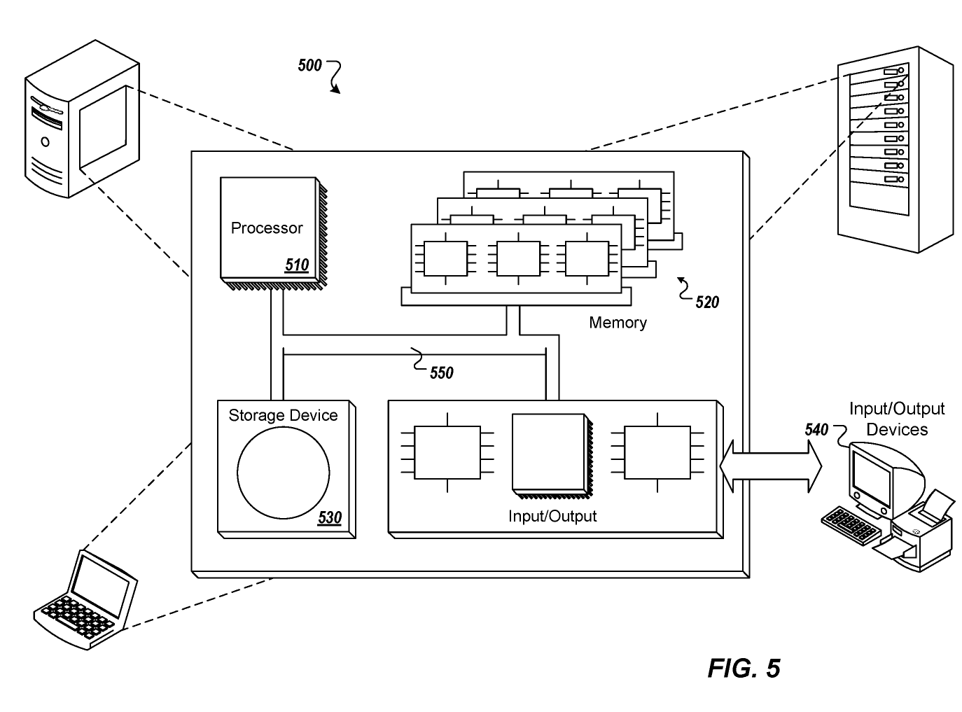

FIG. 5 depicts a schematic diagram of an example computing system 500. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540.

The memory 520 may store information within the system 500. In some implementations, the memory 520 is a computer-readable medium. In some implementations, the memory 520 may include one or more volatile memory units. In some implementations, the memory 520 may include one or more non-volatile memory units.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors for empty container repositioning (ECR) re-planning, the method comprising:
receiving, by the one or more processors, input data comprising one or more original instructions for empty container movement within a network, network configuration data, and a delta supply/demand (S/D) plan, the delta S/D plan defining changes to supply and demand for empty containers at respective locations with respect to a previous S/D plan;
processing, by a preprocessor and constraint generator executed by the one or more processors, at least a portion of the input to provide one or more constraints;
determining, by a delta balancing optimizer executed by the one or more processors, at least one delta instruction based on the one or more constraints, the network configuration data, and the one or more original instructions;
determining, by the one or more processors, whether the at least one delta instruction is of an unacceptable type; and
providing, by the one or more processors, one or more refined delta instructions in response to determining that the at least one delta instruction is of an unacceptable type.

2. The method of claim 1, wherein at least one refined delta instruction comprises one of a new delta instruction, and a modified delta instruction.

3. The method of claim 2, wherein the modified delta instruction comprises a change in one or more of a route, a location, and a size of container.

4. The method of claim 1, wherein unacceptable types comprise unnecessary repositioning, use of a new route that is absent from one or more original instructions, and longer route.

5. The method of claim 1, wherein the constraints comprise one or more of a time constraint, and a container availability constraint.

6. The method of claim 1, wherein a refined delta instruction is provided based on merging of multiple original instructions.

7. The method of claim 1, wherein a refined delta instruction is provided based on modifying an original instruction to include a shorter route than a longer route provided in the original instruction.

8. A non-transitory computer-readable storage medium coupled to one or more processors and having instructions stored thereon which, when executed by the one or more processors, cause the one or more processors to perform operations for empty container repositioning (ECR) re-planning, the operations comprising:
receiving input data comprising one or more original instructions for empty container movement within a network, network configuration data, and a delta supply/demand (S/D) plan, the delta S/D plan defining changes to supply and demand for empty containers at respective locations with respect to a previous S/D plan;
processing, by a preprocessor and constraint generator, at least a portion of the input to provide one or more constraints;
determining, by a delta balancing optimizer, at least one delta instruction based on the one or more constraints, the network configuration data, and the one or more original instructions;
determining whether the at least one delta instruction is of an unacceptable type; and
providing one or more refined delta instructions in response to determining that the at least one delta instruction is of an unacceptable type.

9. The computer-readable storage medium of claim 8, wherein at least one refined delta instruction comprises one of a new delta instruction, and a modified delta instruction.

10. The computer-readable storage medium of claim 9, wherein the modified delta instruction comprises a change in one or more of a route, a location, and a size of container.

11. The computer-readable storage medium of claim 8, wherein unacceptable types comprise unnecessary repositioning, use of a new route that is absent from one or more original instructions, and longer route.

12. The computer-readable storage medium of claim 8, wherein the constraints comprise one or more of a time constraint, and a container availability constraint.

13. The computer-readable storage medium of claim 8, wherein a refined delta instruction is provided based on merging of multiple original instructions.

14. The computer-readable storage medium of claim 8, wherein a refined delta instruction is provided based on modifying an original instruction to include a shorter route than a longer route provided in the original instruction.

15. A system, comprising:
a computing device; and
a computer-readable storage device coupled to the computing device and having instructions stored thereon which, when executed by the computing device, cause the computing device to perform operations for empty container repositioning (ECR) re-planning, the operations comprising:
receiving input data comprising one or more original instructions for empty container movement within a network, network configuration data, and a delta supply/demand (S/D) plan, the delta S/D plan defining changes to supply and demand for empty containers at respective locations with respect to a previous S/D plan;
processing, by a preprocessor and constraint generator, at least a portion of the input to provide one or more constraints;
determining, by a delta balancing optimizer, at least one delta instruction based on the one or more constraints, the network configuration data, and the one or more original instructions;
determining whether the at least one delta instruction is of an unacceptable type; and
providing one or more refined delta instructions in response to determining that the at least one delta instruction is of an unacceptable type.

16. The system of claim 15, wherein at least one refined delta instruction comprises one of a new delta instruction, and a modified delta instruction.

17. The system of claim 16, wherein the modified delta instruction comprises a change in one or more of a route, a location, and a size of container.

18. The system of claim 15, wherein unacceptable types comprise unnecessary repositioning, use of a new route that is absent from one or more original instructions, and longer route.

19. The system of claim 15, wherein the constraints comprise one or more of a time constraint, and a container availability constraint.

20. The system of claim 15, wherein a refined delta instruction is provided based on merging of multiple original instructions.
